(19) United States
(12) Patent Application Publication
(10) Pub. No.: US 2014/0368079 A1
(43) Pub. Date: Dec. 18, 2014

(54) MOTOR AND METHOD FOR ASSEMBLING THE SAME

(71) Applicant: AGENCY FOR SCIENCE, TECHNOLOGY AND RESEARCH, Singapore (SG)

(72) Inventors: Chiew Leong Wong, Singapore (SG); Ralph Stephen Viskochil, Singapore (SG)

(73) Assignee: AGENCY FOR SCIENCE, TECHNOLOGY AND RESEARCH, Singapore (SG)

(21) Appl. No.: 14/378,640

(22) PCT Filed: Feb. 13, 2013
(86) PCT No.: PCT/SG2013/000056

§ 371 Date: Aug. 13, 2014

Related U.S. Application Data
(60) Provisional application No. 61/597,871, filed on Feb. 13, 2012.

(51) Int. Cl. G11B 19/20; H02K 16/02; H02K 15/02

(52) U.S. Cl. CPC G11B 19/2009; H02K 15/02; H02K 16/02
USPC 310/208; 29/598; 310/195; 310/254.1

(57) ABSTRACT

Embodiments provide a method for assembling a motor. The method may include providing a first rotor, a second rotor and a stator; and assembling the first rotor, the second rotor and the stator such that the stator is arranged between the first rotor and the second rotor.

### CROSS-REFERENCE TO RELATED APPLICATIONS

The present application claims the benefit of the U.S. provisional patent application 61/597,871 filed on 13 Feb. 2012, the entire contents of which are incorporated herein by reference for all purposes.

### TECHNICAL FIELD

Embodiments relate generally to a method for assembling a motor. By way of example, embodiments relate to a method for assembling a motor for a data storage device.

### BACKGROUND

Mobile computing and/or communication devices are becoming smaller thereby driving the weight and size of data storage devices down, while requiring large storage capacity in the terabyte range and low power consumption. For example, many mobile computing devices are assuming a thin profile and small form factor for ease of transport and universal operationability. Traditional data storage devices for storing large amounts of data, such as disk drives, have a thickness which is incompatible for such applications.

Thus, what is needed is a light-weight, ultra thin data storage device with a small form factor which is capable of large storage capacities at low power consumption levels. Furthermore, other desirable features and characteristics will become apparent from the subsequent detailed description, taken in conjunction with the accompanying drawings and this background of the disclosure.

### SUMMARY

Various embodiments provide a method for assembling a motor. The method may include providing a first rotor, a second rotor and a stator; and assembling the first rotor, the second rotor and the stator such that the stator is arranged between the first rotor and the second rotor.

Various embodiments provide a motor. The motor may include a first rotor; a second rotor; and a stator arranged between the first rotor and the second rotor.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a schematic having a cross sectional side view of a motor according to various embodiments.

FIG. 2 shows a cross-sectional view of an assembled motor according to various embodiments.

FIG. 3 shows a schematic showing a planar cross sectional view of a stator according to various embodiments.

FIG. 4 shows a flowchart illustrating a method for assembling a motor according to various embodiments.

FIG. 5 shows an exploded cross-sectional view of a motor according to various embodiments.

FIGS. 6A to 6C illustrate a method for assembling various components of the motor according to various embodiments.

FIGS. 7A to 7C illustrate a method for assembling a motor according to various embodiments.

FIG. 8 shows a cross-sectional view of an assembled motor according to various embodiments.

### DESCRIPTION

Various embodiments provide an efficient method of manufacturing a motor, more specifically provide a method for assembling a motor for a device or a product, such as a data storage device. The device or the product may be a mobile consumer electronic device, for example.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments are directed to a method for assembling a motor. The method may include providing a first rotor, a second rotor and a stator; and assembling the first rotor, the second rotor and the stator such that the stator is arranged between the first rotor and the second rotor.

Various embodiments provide a motor, in particular but not limited to a motor for a product such as a data storage device. The product can be a mobile consumer electronic device which can be operable in various orientations, and thus it should be understood that the terms “top”, “bottom”, “base”, “down”, “sideways”, “downwards” etc., when used in the following description are used for convenience and to aid understanding of relative positions or directions, and not intended to limit the orientation of the motor or the product incorporating the motor.

In accordance with various embodiments, a motor may include a first rotor; a second rotor; and a stator arranged between the first rotor and the second rotor.

In various embodiments, the first rotor and the second rotor may be separate parts, and may be affixed to or coupled with each other during assembly.

In various embodiment, the stator may be arranged between the first rotor and the second rotor relative to an axis of rotation of the motor. For example, the first rotor, the stator and the second rotor may be arranged sequentially along the axis of rotation of the motor, wherein these three components or parts of these three components may or may not coincide with each other.

In various embodiments, at least a part of the stator may be exposed from at least one of the first rotor or the second rotor.

In various embodiments, the stator may include an armature winding. In various embodiments, the stator may include a plurality of openings.

In various embodiments, the armature winding may include a plurality of coils, wherein each coil of the plurality of coils is arranged in a spiral manner around each opening of the plurality of openings. In various embodiments, the armature winding may be substantially annular and may be arranged between an inner edge and an outer edge of the stator.

In various embodiments, the motor may further include a bias ring attached onto the stator. At least part of the bias ring may extend beyond an outer edge of the stator, or at least part of the stator may extend beyond an outer edge of the bias ring.

The motor may further include a base for mounting the first rotor, the second rotor and the stator thereon. In an embodiment, the base may be a part of a housing, wherein the housing may include a device (e.g. a data storage device, e.g. a hard disk drive) in which the motor is a part.

Various embodiments described in the context of the motor is analogously valid for the method of assembling the motor, and vice versa.

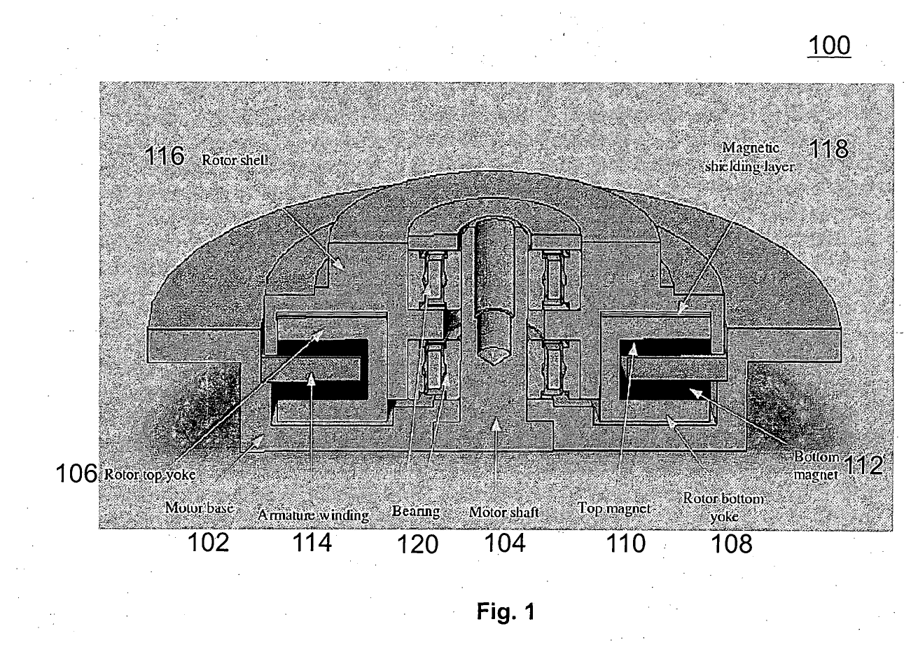

FIG. 1 shows a schematic 100 having a cross sectional side view of a motor, e.g. an axial field motor, according to various embodiments.

The motor may include a motor base 102. The motor may further include a motor shaft 104 extending from the motor base 102. The motor further includes a rotor yoke including a rotor top yoke 106 and a rotor bottom yoke 108. The rotor yoke may be pivotally mounted about a geometric axis of rotation Xr, in relation to the motor base 102. The motor may also include a magnet disk including a top magnet 110 and a bottom magnet 112. The top magnet 110 may be positioned in contact with the rotor top yoke 106. The bottom magnet 112 may be positioned in contact with the rotor bottom yoke 108. The motor may further include a stator having an armature winding 114 positioned between the top magnet 110 and the bottom magnet 112. The motor may also include a rotor shell 116 disposed over the magnet disc so as to enclose all the components therewithin. Further, the motor may include a magnetic shielding layer 118 positioned between the rotor top yoke 106 and the rotor shell 116 so as to shield the magnetic field generated by the magnetic disc. The motor may be configured to rotate about the first axis or geometric axis Xr either on hydrodynamic bearings or ball bearings 120. While FIG. 1 shows that the stator or armature winding 114 is sandwiched by magnets 110 and 112, it may be envisioned that magnets are provided only on one side of the stator or armature winding 114.

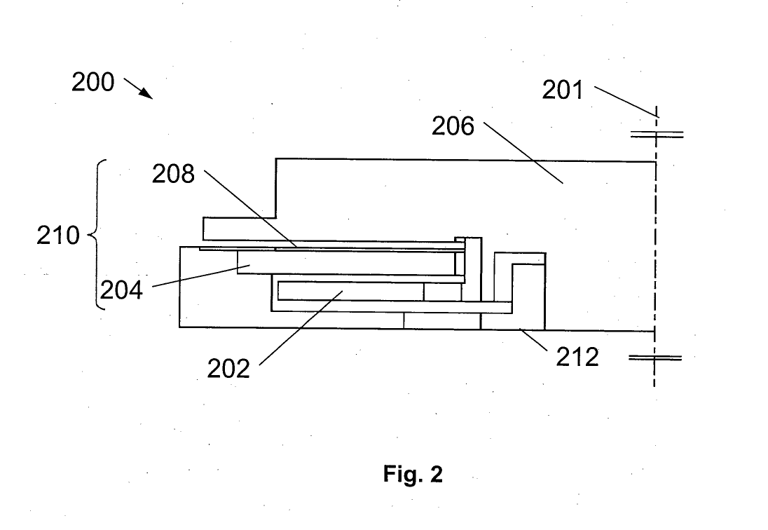

FIG. 2 shows a cross-sectional view of an assembled motor according to various embodiments. For simplicity, only half of the motor 200 from a center line 201 is shown, wherein the center line 201 defines an axis of rotation of the motor 200, i.e. an axis around which the motor 200 is rotated.

The motor 200 may include a first rotor 202, a stator 204, and a second rotor 206, wherein the stator 204 is arranged between the first rotor 202 and the second rotor 206. In an embodiment, the stator 204 is arranged between the first rotor 202 and the second rotor 206 relative to the axis 201. For example, the first rotor 202, the stator 204 and the second rotor 206 may be arranged sequentially along the axis 201, wherein these three components or parts of these three components may or may not coincide with each other. In various embodiments, the stator 204 arranged between the first rotor 202 and the second rotor 206 may include that the stator 204 is surrounded by the first rotor 202 and the second rotor 206. In various embodiments, the stator 204 arranged between the first rotor 202 and the second rotor 206 may include that at least a portion of the stator 204 may be arranged over at least a portion of the first rotor 202, and at least a portion of the second rotor 206 may be arranged over at least a portion of the stator 204. The first rotor 202, the stator 204 and the second rotor 206 in such an arrangement may be referred to as a motor sub-assembly 210.

In various embodiments, the stator 204 may be partially exposed from at least one of the first rotor 202 or the second rotor 206.

The stator 204 may be attached to a base 212 or to a part of a housing of a device (e.g. a data storage device) which serves as a base 212 of the motor. For example, the base 212 may form a portion of a housing, wherein the housing may include a data storage device (e.g. a hard disk drive) in which the motor is a part. In an embodiment shown in FIG. 2, the motor sub-assembly 210 is mounted on the base 212.

The motor 200 as shown in the embodiment of FIG. 2 is fully assembled or mounted to a device (e.g. to a housing of a device), wherein the stator 204 is fixedly coupled or secured to the part of the device, e.g. to the housing of the device.

According to an embodiment, the motor 200 may further include a bias ring 208 attached to the stator 204. In various embodiments, the bias ring 208 may be arranged on the stator 204. In various embodiments, the bias ring 208 may be embedded in the stator 204, or may be formed as an integral part of the stator 204. In various embodiments, at least part of the bias ring 208 may extend beyond an outer edge of the stator 204, or at least part of the stator 204 may extend beyond an outer edge of the bias ring 208. In various embodiments, the bias ring 208 may include or may be or may be made of or may be made from a material of 400 series stainless steel. In various embodiments, the bias ring 208 may include or may be or may be made of or may be made from mild steel or iron for their magnetic properties.

In an embodiment, the second rotor 206 may include a hub coupled with a fluid dynamic bearing. The bias ring 208 may be attached to the base 212 such that interaction with magnets provided in the motor (e.g. provided in the second rotor 206) creates a desired magnetic bias force between the second rotor 206 (e.g. the hub of the second rotor 206) and the base 212.

It is understood that the bias ring 208 may be optionally included in the motor 200, e.g. when fluid dynamic bearings are used in the motor 200. For example, when fluid dynamic bearings with single thrust bearing surface are used, the bias ring 208 may be included in the motor 200. For example, when fluid dynamic bearings with dual thrust surfaces are used, the bias ring 208 may not be included in the motor 200. In an example, when ball bearings are used, the bias ring 208 may not be included in the motor 200.

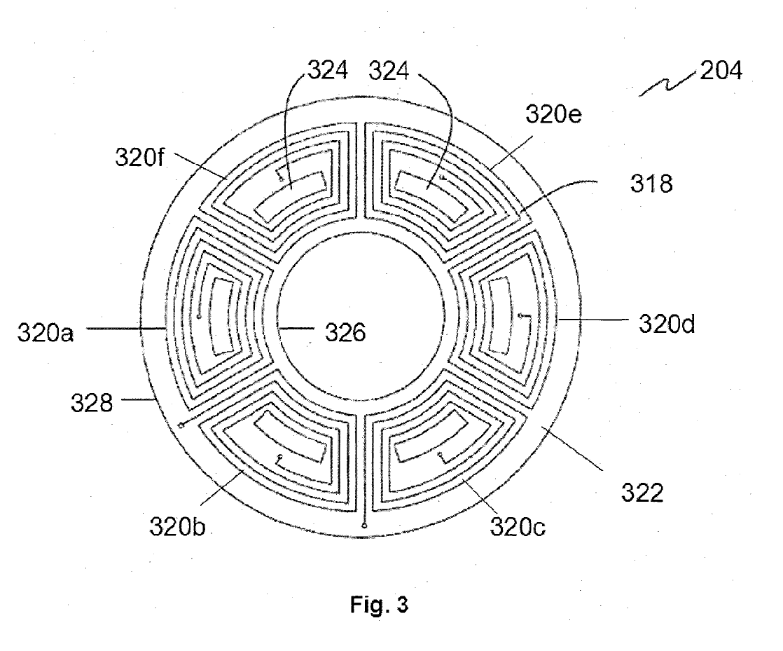

FIG. 3 is a schematic showing a planar cross sectional view of a stator according to various embodiments.

The stator 204 may include an armature winding 318. In various embodiments, the armature winding 318 may include a plurality of coils 320a, 320b, 320c, 320d, 320e and 320f. For avoidance of doubt, although FIG. 3 shows six coils 320a, 320b, 320c, 320d, 320e and 320f, other numbers of coils may be possible.

In an exemplary embodiment wherein the armature winding 318 is formed by six coils 320a, 320b, 320c, 320d, 320e and 320f, the six coils may be divided into three pairs. Coils 320a and 320b may form a first pair. Coils 320b and 320e may form a second pair. Coils 320c and 320f may form a third pair. The coils in each pair may be of the same electrical degree (or phase) at any point in time. One pair may differ from another pair by 120 electrical degrees. The armature winding 318 may be described as a “120 degrees” concentrated winding. In various embodiments where the armature winding 318 may be described as “120 degrees” concentrated winding, the winding 318 utilizes fundamental or the second order electromagnetic field harmonics in spindle motor operations. The embodiment of 6 coils/120 degrees is just an example. In various embodiments, there may be different quantity of coils. The quantity of coils may be multiples of spindle motor driving cut-rent phases. For example, for 3-phase, the number of coils may be 6, 12, 18, or 24, etc.

In various embodiments, the stator 204 may have a substrate 322, for example, a substantially planar substrate. In various embodiments, the stator 204 may be or may include a printed circuit board (PCB). In various embodiments, the stator 204 may be or may include a substantially planar substrate 322 printed with conductive traces (e.g. the armature winding 318) in patterns which, when in operable interference with a magnetic field, would produce forces suitable for operating the motor.

In various embodiments, the armature winding 318, e.g. the plurality of coils 320a, 320b, 320c, 320d, 320e and 320f, may be formed or provided on the substrate 322. The armature winding 318 may be formed by printed circuit board traces, bonded wires, fine pattern coils or other wire and circuit technologies.

In various embodiments, the stator 204 may include a plurality of openings 324. The armature winding 318 may be arranged or configured in a spiral manner around the openings 324. For example, each coil of the plurality of coils 320a, 320b, 320c, 320d, 320e and 320f may form a spiral pattern surrounding the respective opening of the plurality of openings 324.

In various embodiments, the armature winding 318, e.g. the plurality of coils 320a, 320b, 320c, 320d, 320e and 320f, may be substantially annular and distributed between an inner edge 326 of the substrate 322 and an outer edge 328 of the substrate 324. The plurality of coils 320a, 320b, 320c, 320d, 320e and 320f may be in a plane defined by the substrate 322.

The substrate 322 may include a plurality of layers. The plurality of coils 320a, 320b, 320c, 320d, 320e and 320f may be on different layers of the plurality of layers. For instance, the substrate 322 may include a first layer and a second layer. Coils 320a, 320d may be on a first surface of the first layer. Coils 320b, 320e may be between a second surface of the first layer (opposite the first surface of the first layer) and a first surface of a second layer. The second surface of the first layer may be in contact with the first surface of the second layer. Coils 320c, 320f may be on a second surface of the second layer (opposite the first surface of the second layer). The plurality of coils 320a, 320b, 320c, 320d, 320e and 320f may form a two dimensional multi-phase winding. In other words, the armature winding 318 may be a two dimensional winding. The winding 318 (e.g. the plurality of coils 320a, 320b, 320c, 320d, 320e and 320f) in different surfaces or layers may be electrically connected by conductive vias.

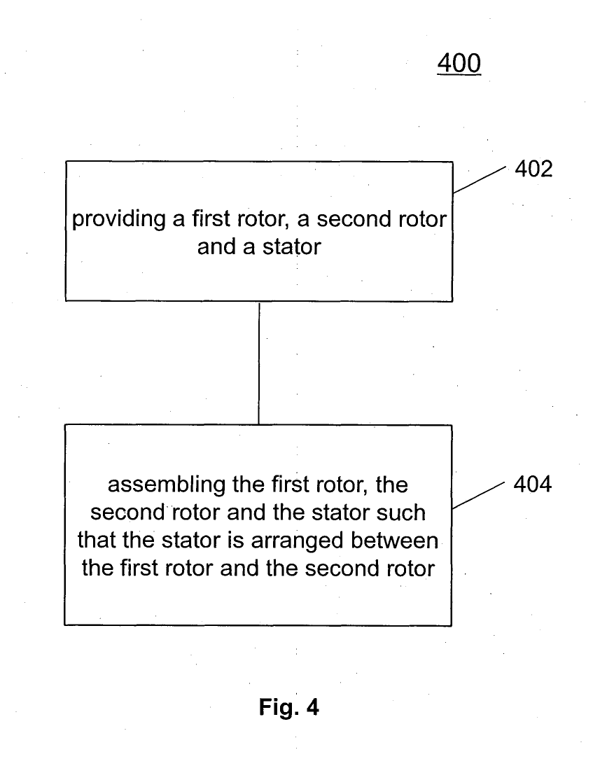

FIG. 4 shows a flowchart 400 illustrating a method for assembling a motor according to various embodiments.

At 402, a first rotor, a second rotor and a stator are provided.

At 404, the first rotor, the second rotor and the stator are assembled such that the stator is arranged between the first rotor and the second rotor.

In various embodiment, the stator may be arranged between the first rotor and the second rotor relative to an axis of rotation of the motor. i.e. the axis around which the first rotor and the second rotor rotate. For example, the first rotor, the stator and the second rotor may be arranged sequentially along the axis of rotation of the motor, wherein these three components or parts of these three components may or may not coincide with each other.

The method may further include attaching a bias ring onto the stator. In various embodiment, the bias ring may be attached onto the stator before assembling the first rotor, the second rotor and the stator. In various embodiments, the bias ring may be attached onto the stator during assembling the first rotor, the second rotor and the stator.

In accordance with various embodiments, the first rotor, the second rotor and the stator may be assembled such that at least a part of the stator is exposed from at least one of the first rotor or the second rotor.

In accordance with various embodiments, the method may include receiving the first rotor in a base. The first rotor may be received in a recess of the base.

The method may further include coupling the stator to the base, such that at least part of the first rotor is arranged between the stator and the base. In various embodiment, at least part of the first rotor is arranged between the stator and the base relative to an axis of rotation of the motor. i.e. the axis around which the first rotor rotates. For example, the base, the first rotor, and the stator may be arranged sequentially along the axis of rotation of the motor, wherein these three components or parts of these three components may or may not coincide with each other.

The method may further include affixing the second rotor onto the first rotor, such that the second rotor is mated with the base and such that the stator is arranged between the first rotor and the second rotor.

In accordance with various embodiments, the first rotor, the second rotor and the stator are assembled to form a motor sub-assembly. The method may further include arranging the motor sub-assembly on a base. In an example, the motor sub-assembly may be arranged on the base such that the first rotor is received in a recess of the base.

In various embodiments, the motor sub-assembly may be arranged on the base such that the stator is received on a step of the base, wherein the step is adjacent to the recess of the base.

In various embodiment, the method may further include adhering an outer edge of the stator to a complementary side surface of the step and receiving the stator on a rest of the step.

In various embodiments, the method may include attaching the stator to the base by means of at least one of a fastener or epoxy.

Various embodiments of assembling the motor are described in more detail below.

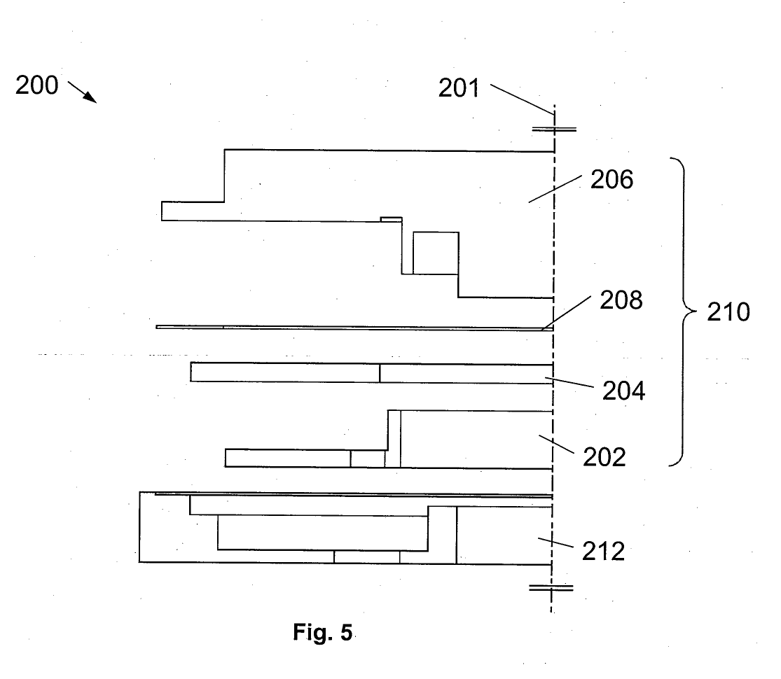

FIG. 5 shows an exploded cross-sectional view of a motor according to various embodiments. For example, FIG. 5 shows various components of a motor 200 (e.g. the motor 200 of FIG. 2) prior to assembling.

The various components may include the first rotor 202, the stator 204 and the second rotor 206, with the stator 204 arranged between the first rotor 202 and the second rotor 206 relative to the axis 201 of rotation of the motor 200. Such an arrangement may be referred to as a motor sub-assembly 210. In various embodiments, a bias ring 208 may be provided, e.g. in the motor sub-assembly 210, e.g. on the stator 204. In various embodiments, the motor 200 may include a base 212. As shown in FIG. 5, the base 212 may include one or more recess or step for receiving one or more of the first rotor 202, the stator 204, the second rotor 206 and the bias ring 208.

The method for assembling various components of the motor 200 is described below.

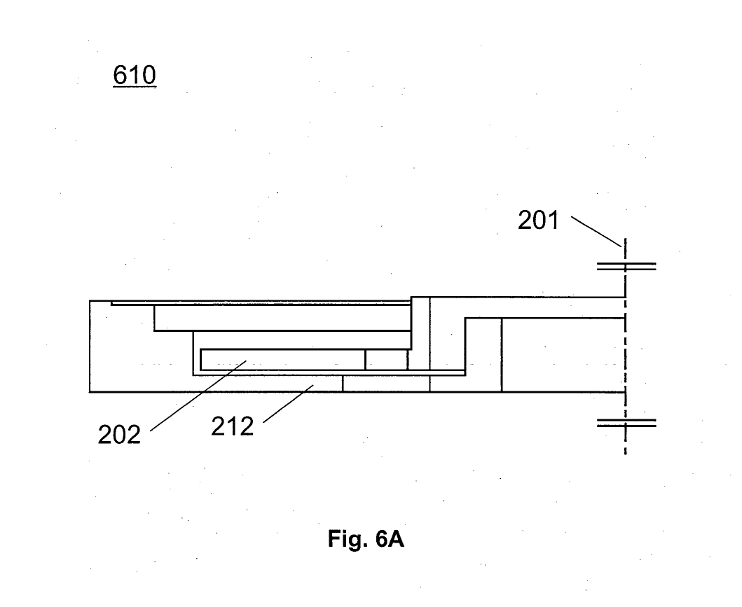

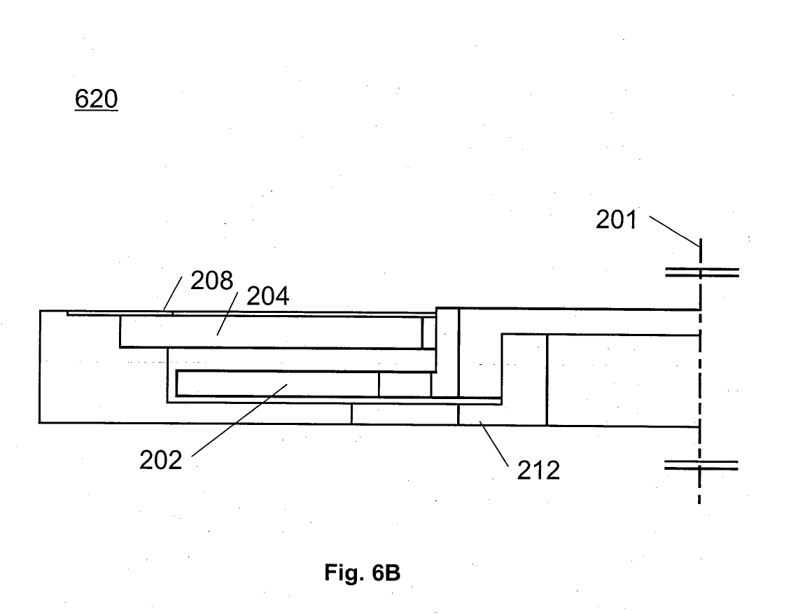

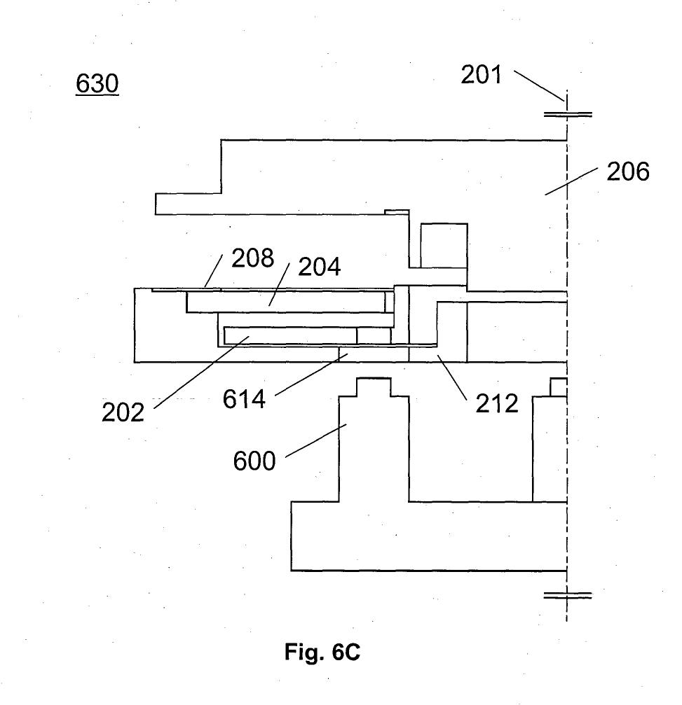

In the diagram 610 of FIG. 6A, the first rotor 202 is received in the base 212. In an example, the first rotor 202 may be received in a recess of the base 212.

In the diagram 620 of FIG. 6B, the stator 204 is coupled to the base 212, such that at least part of the first rotor 202 is arranged between the stator 204 and the base 212. In an embodiment, the operable part of the first rotor 202 is arranged between the stator 204 and the base 212. In various embodiment, the first rotor 202 may be arranged between the stator 204 and the base 212 relative to the axis 201 of rotation of the motor 200. For example, the base 212, the first rotor 202, and the stator 204 may be arranged sequentially along the axis 201, wherein these three components 212, 202, 204 or parts of these three components 212, 202, 204 may or may not coincide with each other.

In an embodiment, the stator 204 may include a bias ring 208, which may be embedded in the stator 204 or may be formed as an integral part of the stator 204. When the stator 204 is coupled to the base 212, the bias ring 208 is simultaneously coupled to the base 212.

In an embodiment, after coupling the stator 204 to the base 212, a bias ring 208 may be further attached to the stator 204, e.g. onto a surface of the stator 204.

In the embodiments shown in FIG. 6B, at least part of the bias ring 208 extends beyond the outer edge of the stator 204. In other words, compared with the bias ring 208, the stator 204 is radially nearer the shaft center line 201 of the motor 200 (when in assembly), or the bias ring 208 has a larger outer diameter than the stator 204 such that at least part of the bias ring 208 extends beyond the stator 204. In other embodiments, the bias ring 208 may be provided such that at least part of the stator extends beyond the outer edge of the bias ring as will be described below.

It is understood that the bias ring 208 may be optionally included in the motor 200 when necessary, e.g. when fluid dynamic bearings are used in the motor 200.

In the diagram 630 of FIG. 6C, the second rotor 206 is affixed onto the first rotor 202, such that the second rotor 206 is mated with the base 212 and such that the stator 204 is arranged between the first rotor 202 and the second rotor 206. In various embodiments, the second rotor 206 is affixed to the first rotor 202 simultaneously as the second rotor 206 is mated with the base 212. In various embodiment, the stator 204 may be arranged between the first rotor 202 and the second rotor 206 relative to the axis 201. For example, the first rotor 202, the stator 204 and the second rotor 206 may be arranged sequentially along the axis 201, wherein these three components or parts of these three components may or may not coincide with each other.

In an embodiment, the second rotor 206 may include a hub coupled with a fluid dynamic bearing. The bias ring 208 may be provided such that interaction with magnets provided in the motor (e.g. provided in the second rotor 206) creates a desired magnetic bias force between the second rotor 206 (e.g. the hub of the second rotor 206) and the base 212.

In an embodiment, the base 212 may include one or more access holes 614. By providing the access hole 614 in the base 212, e.g. at the bottom surface of the base 212, an assembly tool 600 may be used to force a mating of the first rotor 202 and the second rotor 206, e.g. by pushing the first rotor 202 to the second rotor 206 through the access hole 614, to achieve a predetermined overall height of the motor 200. The overall assembly height of the motor 200 may be determined by the joining of the second rotor 206 (e.g. including fluid dynamic bearings) to the base 212.

After affixing the second rotor 206 onto the first rotor 202, the motor 200 as shown in FIG. 2 may be achieved.

The assembling method illustrated with reference to FIGS. 6A to 6C may be a top-down motor assembly method.

In various embodiments, a top-down motor assembly method is provided. The assembly of the motor as well as the mounting of the motor to a product (such as a data storage device) can be performed without a need to deliver or access components of the motor for the assembly thereof from more than one direction. Generally, it is preferred to access the components or the assembly in a top-down fashion—that is to say, from a direction substantially clear of a platform, work station, or conveyor etc. that is used to support the components or the assembly. The top-down assembly may refer to presenting or moving the components in a direction substantially parallel to the center line 201. Advantageously, this top-down assembly facilitates automation and efficient manufacture. Nevertheless, owing to product requirements, e.g., where interlocking or interfacing components are involved (such as in the case of motors for data storage devices as described above), there may be a need to provide forces from opposing directions to achieve the desired fit and the design of a top-down assembly approach may not be easily implemented. Additionally, for axial field motors where the spacing between the first rotor and the second rotor is substantially reduced as compared to radial field motors, the substantially planar stator itself may add to the challenge of the top-down assembly as there is substantially less room for accessing the components from a direction clear of the base or to reach sideways and downwards to secure, adjust or apply necessary forces for proper motor assembly.

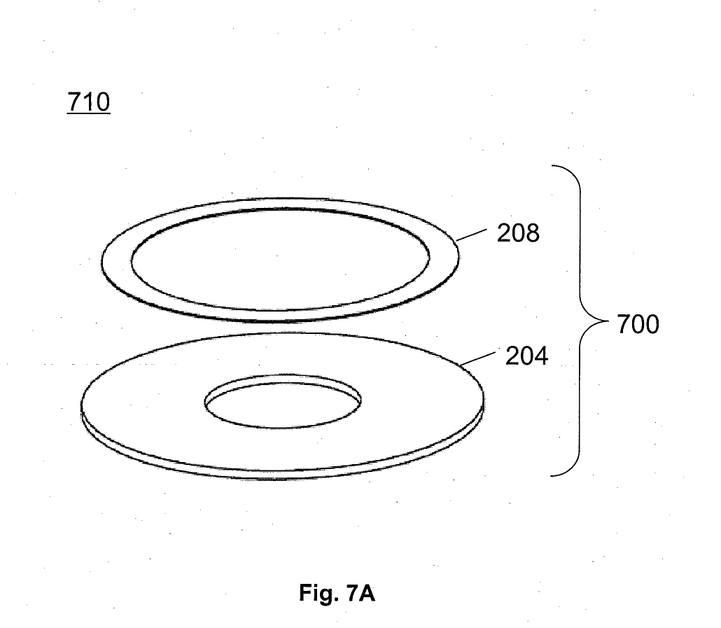

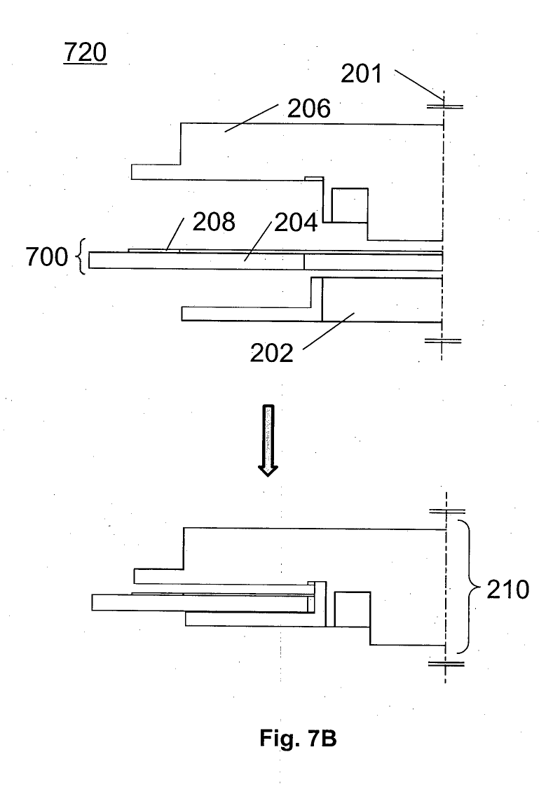

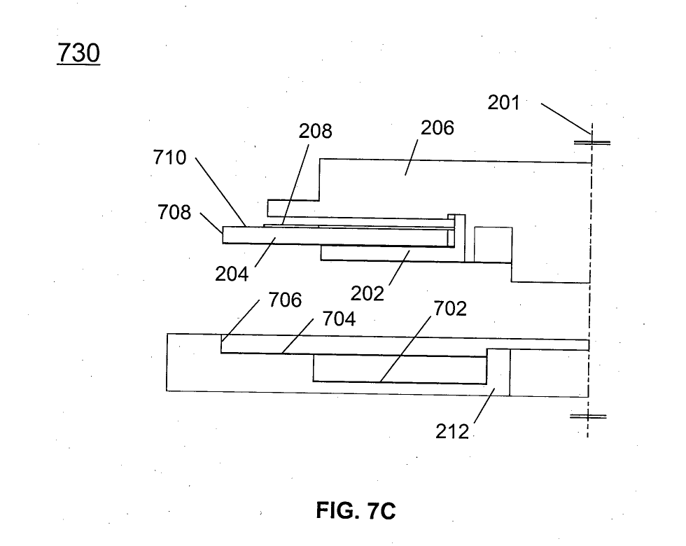

FIGS. 7A to 7C illustrate a method for assembling various components of the motor 200 according to various embodiments.

According to the embodiments of FIGS. 7A to 7C, pre-assembly or partial assembly of selected components of the motor 200 may be performed prior to attachment to the base 212. For example, the first rotor 202, the stator 204 and the second rotor 206 as shown in FIG. 5 may be assembled to form the motor sub-assembly 210, and the motor sub-assembly 210 is then attached to the base 212.

In the diagram 710 of FIG. 7A, the bias ring 208 is attached to the stator 204 to form a stator sub-assembly 700. The bias ring 208 may be coupled to a substantially planar stator 204. In an embodiment, this attachment is performed by bringing the bias ring 208 and the stator 204 together in a top-down direction manner.

The stator 204 may be the stator described in FIG. 3. In various embodiments, the stator 204 may be or may include a printed circuit board (PCB). In various embodiments, the stator 204 may be or may include a substantially planar substrate 322 printed with conductive traces (e.g. the armature winding 318 of FIG. 3) in patterns which, when in operable interference with a magnetic field, would produce forces suitable for operating the motor.

In various embodiments, the stator 204 may have a larger outer diameter than the bias ring 208, such that at least part of the stator 204 radially extends beyond the bias ring 208 after assembling, i.e. the bias ring 208 is radially nearer the center line 201 of the motor 200. It is understood that in other embodiments, the bias ring 208 may be provided such that at least part of the bias ring 208 extends beyond the outer edge of the stator.

In the diagram 720 of FIG. 7B, the first rotor 202 and the second rotor 206 are coupled together proximal to the center line 201 of the motor 200, with the stator sub-assembly 700 disposed therebetween.

In various embodiments, the coupling of the first rotor 202 and the second rotor 206 may be performed in a top-down manner. For example, the stator sub-assembly 700 may be coupled onto the first rotor 202, and the second rotor 206 is then affixed to the first rotor 202 with the stator sub-assembly 700 arranged between the first rotor 202 and the second rotor 206, so as to form the motor sub-assembly 210. In various embodiment, the stator sub-assembly 700 may be arranged between the first rotor 202 and the second rotor 206 relative to the axis 201 of rotation of the motor 200. For example, the first rotor 202, the stator sub-assembly 700 and the second rotor 206 may be arranged sequentially along the axis 201, wherein these three components or parts of these three components may or may not coincide with each other.

In various embodiments, the stator sub-assembly 700 may be disposed in a gap defined by the operable parts of the first rotor 202 and the second rotor 206. The stator sub-assembly 700, the first rotor 202 and the second rotor 206 may then be coupled to each other simultaneously, so as to form the motor sub-assembly 210.

In various embodiments, the motor sub-assembly 210 may include bearings. In an embodiment, the bearings may be included in the second rotor 206. The bearings may be conventional ball bearings, fluid dynamic bearings, and the like.

In the diagram 730 of FIG. 7C, the motor sub-assembly 210 formed in FIG. 7B may be arranged on the base 212.

In various embodiment, the motor sub-assembly 210 and the base 212 may be presented to each other in a top-down fashion for assembly. The base 212 may be the base of the motor 200 alone, or may be a component that doubles as part of a structure in a device like a data storage device.

In various embodiments, the motor sub-assembly 210 may be delivered onto the base 212 such that the first rotor 202 is received in a motor recess 702 in the base 212.

In various embodiments, the base 212 may be configured with a step 704 adjacent to the recess 702. In various embodiments, the motor sub-assembly 210 may be arranged on the base 212 such that the stator 204 is received on the step 704 of the base 212. In an embodiment, the step 704 has a rest configured to receive the stator 204. In various embodiments, the stator 204 of the motor sub-assembly 210 may be coupled to the base 212, by adhering the outer edge or circumferential side 708 of the stator 204 to a complementary side surface 706 of the step 704 in the base 212.

In various embodiments, the stator 204 may be coupled to the base 212 by means of at least one of a fastener or epoxy.

In various embodiments, the stator 204 may be partially exposed from at least one of the first rotor 202 and the second rotor 206, such that forces can be applied in a top-down fashion to the exposed part 710 of the stator 204 to abut the stator 204 to the rest of the step 704, thereby achieving a predetermined height of the stator 204 relative to the base 212 and facilitating coupling of the stator 204 to the base 212. Concurrently, a desired spacing between the stator 204 and the first rotor 202, and a desired spacing between the stator 204 and the second rotor 206 can be easily achieved.

In the above embodiments, the bias ring 208 is attached to the stator 204. In other embodiments wherein the bias ring 208 is not provided, the pre-assembling process in FIG. 7A may be omitted, and the assembling process in FIG. 7B may be performed only on the first rotor 202, the stator 204 and the second rotor 204. The motor sub-assembly 210 formed in FIG. 7B may thus only include the first rotor 202, the stator 204 and the second rotor 204.

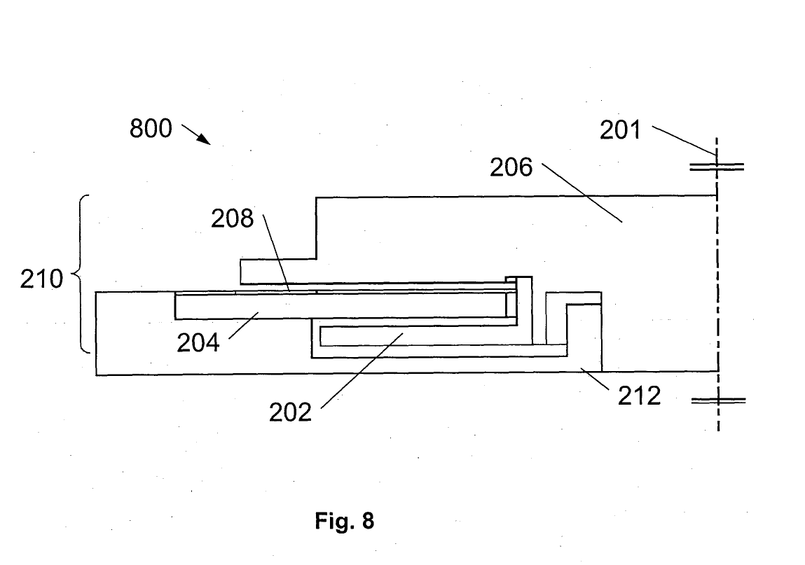

After mounting the motor sub-assembly 210 on the base 212, the final motor assembly 800 is achieved and shown in FIG. 8.

The motor 800 of FIG. 8 is similar to the motor 200 of FIG. 2, with the difference that the stator 204 extends radially beyond the outer edge of the bias ring 208 in the motor assembly 800 while the bias ring 208 extends radially beyond the outer edge of the stator 204 in the motor assembly 200. It is understood that the method of FIGS. 7A to 7C may be used to form the motor 200 of FIG. 2 or the motor 800 of FIG. 8, and the method of FIGS. 6A to 6C may be used to form the motor 200 of FIG. 2 or the motor 800 of FIG. 8, in various embodiments.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for assembling a motor, the method comprising:
providing a first rotor, a second rotor and a stator; and
assembling the first rotor, the second rotor and the stator such that the stator is arranged between the first rotor and the second rotor.

2. The method of claim 1, further comprising:
attaching a bias ring onto the stator.

3. The method of claim 2, further comprising:
attaching the bias ring onto the stator before assembling the first rotor, the second rotor and the stator.

4. The method of claim 1, further comprising:
receiving the first rotor in a base.

5. The method of claim 4, further comprising:
receiving the first rotor in a recess of the base.

6. The method of claim 4, further comprising:
coupling the stator to the base, such that at least part of the first rotor is arranged between the stator and the base.

7. The method of claim 4, further comprising:
affixing the second rotor onto the first rotor, such that the second rotor is mated with the base and such that the stator is arranged between the first rotor and the second rotor.

8. The method of claim 1, wherein the first rotor, the second rotor and the stator are assembled to form a motor sub-assembly, and the method further comprises:
arranging the motor sub-assembly on a base.

9. The method of claim 8, wherein the motor sub-assembly is arranged on the base such that the first rotor is received in a recess of the base.

10. The method of claim 9, wherein the motor sub-assembly is arranged on the base such that the stator is received on a step of the base, the step being adjacent to the recess of the base.

11. The method of claim 10, further comprising:
adhering an outer edge of the stator to a complementary side surface of the step and receiving the stator on a rest of the step.

12. The method of claim 8, further comprising:
attaching the stator to the base by means of at least one of a fastener or epoxy.

13. The method of claim 1, further comprising:
assembling the first rotor, the second rotor and the stator such that at least a part of the stator is exposed from at least one of the first rotor or the second rotor.

14. A motor comprising:
a first rotor;
a second rotor; and
a stator arranged between the first rotor and the second rotor.

15. The motor of claim 14,
wherein the stator comprises an armature winding and a plurality of openings.

16. The motor of claim 15,
wherein the armature winding comprises a plurality of coils, each coil of the plurality of coils being arranged in a spiral manner around a respective opening of the plurality of openings.

17. The motor of claim 15,
wherein the armature winding is substantially annular and is arranged between an inner edge and an outer edge of the stator.

18. The motor of claim 14, further comprising a bias ring attached onto the stator, at least part of the bias ring extending beyond an outer edge of the stator.

19. The motor of claim 14, further comprising a bias ring attached onto the stator, at least part of the stator extending beyond an outer edge of the bias ring.

20. The motor of claim 14, further comprising:
a base for mounting the first rotor, the second rotor and the stator thereon.
